(19) United States
(12) Patent Application Publication
(10) Pub. No.: US 2005/0091474 A1
(43) Pub. Date: Apr. 28, 2005

(54) Fuse configurable alternate behavior of a central processing unit

(75) Inventors: Igor Wojewoda, Tempe, AZ (US); Joseph W. Triece, Phoenix, AZ (US)

Correspondence Address: BAKER BOTTS, LLP, 910 LOUISIANA, HOUSTON, TX, 77002-4995, US

(73) Assignee: Microchip Technology Incorporated

(21) Appl. No.: 10/969,512

(22) Filed: Oct. 20, 2004

Related U.S. Application Data
(60) Provisional application No. 60/514,271, filed on Oct. 24, 2003.

(51) Int. Cl. G06F 9/30

(52) U.S. Cl. 712/209; 712/229; 712/227

(57) ABSTRACT

A method, system and apparatus are provided for alternating instruction sets in central processing units. A microcontroller is provided with a configuration mechanism, such as a fuse that, depending upon the setting, determines which of multiple instruction sets (or multiple parts of a single instruction set) can be processed by the central processing unit. By changing the fuse setting the characteristics of the central processing unit, and thus the microcontroller as a whole, can be changed.

### CROSS REFERENCE TO RELATED APPLICATION

The application is a conversion of, and claims priority to, U.S. Provisional Application Ser. No. 60/514,271 which was filed on Oct. 24, 2003 by the same inventors as the present application and is herein incorporated by reference for all purposes.

### FIELD OF THE INVENTION

The present invention relates generally to microprocessors. More specifically, the present invention is related to selectively identifying one or more instruction sets for implementation by a central processing unit.

### BACKGROUND OF THE INVENTION TECHNOLOGY

Microcontroller units (“MCU”) have been used in the manufacturing and electrical industries for many years. Microcontrollers are typically equipped with a central processing unit (“CPU”) and ancillary elements. As with all hardware based devices, however, once the device has been released to the market, some users find need for modifications to the instruction set of the CPU. Unfortunately, once the CPU has been embedded within the semiconductor, modifications to the semiconductor substrate, and hence the behavior of the device is not possible. There is, therefore, a need in the art for a CPU that can accommodate new instructions yet still operate with older instructions.

### SUMMARY OF THE INVENTION

The invention overcomes the above-identified problems as well as other shortcomings and deficiencies of existing technologies by providing a microcontroller that has a fuse setting that selects between alternate instruction sets.

For microcontrollers that have a limited number of instructions that can be encoded as part of its opcode space, the ability to select between two or more instruction sets is desirable. In order to include new instructions that optimize C-compiler code compression, behavior of existing instructions has to be altered. However, in order to facilitate backward compatibility with previously-developed code, the CPU must exhibit dual behavior: one or more targeted to the new instructions, and one targeted toward the legacy code. Additional instructions (in alternative sets) may be added. Moreover, the instruction selection mechanisms can be arranged in parallel and/or series in order to broaden the selections possible to two or more instruction sets.

Features and advantages of the invention will be apparent from the following description of the embodiments, given for the purpose of disclosure and taken in conjunction with the accompanying drawings.

### BRIEF DESCRIPTION OF THE DRAWINGS

A more complete understanding of the present disclosure and advantages thereof may be acquired by referring to the following description taken in conjunction with the accompanying drawings, wherein:

FIG. 1 is a block diagram illustrating the configuration of a central processing unit with an instruction set selector according to the teachings of the present invention.

FIG. 2 is a block diagram illustrating the configuration of a central processing unit with a fuse according to the teachings of the present invention.

FIG. 3 is a flowchart illustrating a method of instruction set selection according to the teachings of the present invention.

FIG. 4 is a flowchart illustrating another embodiment of the method of instruction set selection according to the teachings of the present invention.

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

A method, system and apparatus are provided for alternating instruction sets in central processing units. A microcontroller is provided with a fuse setting that, depending upon that setting, determines which of multiple instruction sets will be processed by the central processing unit. By changing the fuse setting the characteristics of the central processing unit, and thus the microcontroller as a whole, can be changed. The fuse settings can be changed so that one of two or more instruction sets can be chosen for implementation by the central processing unit. Alternatively, the fuse setting can be changed so that one or more subsets of a single instruction set can be executed, or disabled.

Whether or not a second instruction set, or parts of a first instruction set, are enabled for execution by the central processor unit can be accomplished in a variety of ways. One example of switching is to use a fuse. The fuse can be a flash-based fuse that can reside externally to the processor or be embedded within the processor. Alternatively, the fuse can be set at the time of manufacture by, for example, burning away an element of the fuse, so that the processor exhibits different behaviors based on the fuse setting (and thus which instructions are executable). While a single fuse is depicted in the illustrative examples below, it will be understood that multiple fuses, or fuse equivalents, may be arranged in series and/or parallel to provide a richer array of choices of instructions, and thus behaviors for the same processor. In alternate embodiments, enhancements other than instructions may be implemented by setting (or unsetting) the fuse or fuses. While it is preferable that the fuse be programmable or configurable (via, for example, flashing), it is not necessary that the fuse be programmable in order to practice the invention.

The illustrative embodiment has two instruction sets. However, the present invention is capable of utilizing more than two instruction sets, or one or more parts of the same instruction set. The special operating modes and RESET modes are configured using two registers, conveniently called “CONFIG4L” and “TCFG4L”. A STVREN setting enables/disables the stack overflow/stack underflow reset. When set, the RESET due to stack overflow/underflow is enabled. When cleared, RESETs due to stack overflow/underflow are disabled. Table 1 illustrates the registers and their potential settings.

TABLE 1
Configuration Register 4L
CONFIG4L:

| | | | | | | | |
|---|---|---|---|---|---|---|---|
| R/P-1 | R/P-0 | U-0 | U-0 | U-0 | R/P-1 | U-0 | R/P-1 |

TCFG4L:

| R/W-1 | R/W-1 | U-0 | U-0 | U-0 | R/W-1 | U-0 | R/W-1 |
|---|---|---|---|---|---|---|---|
| BKBUG | ENHCPU | — | — | — | LVP | — | STVREN |
| bit 7 | | | | | | | bit 0 |

In the table above, ‘R’ indicates a readable bit, ‘W’ indicates a writeable bit, ‘P’ indicates a programmable bit, ‘U’ indicates an unimplemented bit (but read as ‘0’), 0 indicates that the bit is cleared, ‘x’ indicates the bit is unknown, and a dash (‘-’) followed by a digit indicates the fuse, namely the factory programmed value register, and the value at test RESET. The BKBUG is the background debugger enable bit. The ENHCPU is the enhanced CPU enable bit. In other words, in this embodiment, the ENHCPU bit is the fuse that enables alternate (or enhanced) instructions to be executed by the processor. LVP is the low voltage programming enable bit, and STVREN is the stack overflow reset enable bit. Each of the forgoing bits can be enabled or disabled by setting the bit to, for example, ‘1’ or ‘0’, respectively.

The selection of the instruction set can be accomplished in a variety of ways. In this illustrative embodiment, the LVP fuse enables/disables low-voltage programming selection. When set, low-voltage programming is enabled. In-circuit serial programming (“ICSP”) mode may be entered with either high voltage on the Vₚₚ pin, or a logic high on the program (“PGM”) pin. When cleared, low-voltage programming is disabled and the only means to enter test mode is with high voltage on the Vₚₚ pin; the PGM pin will be ignored.

In this embodiment, the parameter conveniently named “ENHCPU” enables/disables enhanced features of the CPU that are meant to be used with the C-compiler. Backwards compatibility is provided when the ENHCPU fuse is set to ‘0’. In this embodiment, use of the C-compiler alternate coding is enabled when the ENHCPU fuse is set to ‘1’. Alternate embodiments may reverse the setting of the ENHCPU fuse (e.g., backwards compatibility is provided with the ENHCPU is set to ‘1’).

When the ENHCPU fuse is cleared, multiple instructions can be added to enhance the capabilities of the CPU. Some of the enhanced instructions can be, for example, CALLW, MOVSF, MOVSS, PUSHL, ADDLFSR, ADDULNK, SUBLFSR, and SUBULNK. Moreover, when the fuse is cleared, an addressing mode is added that limits the number of addresses using the access bit encode of an indexed address with literal offset. In alternate embodiments, when the ENHCPU fuse is cleared, a different instruction set may be implemented, or alternate addressing modes may be enabled/disabled.

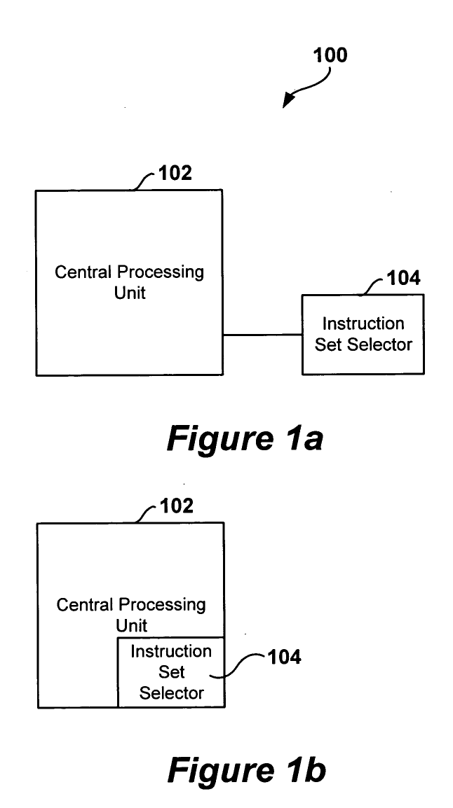

FIG. 1a illustrates an embodiment of the invention disclosed herein. Specifically, the central processing unit 102 is operative with an instruction set selector 104 (e.g. the ENHCPU fuse). The instruction set selector 104 may be positioned in any convenient location, either as part of the central processing unit (see FIG. 1b), or elsewhere on, for example, the motherboard (not shown).

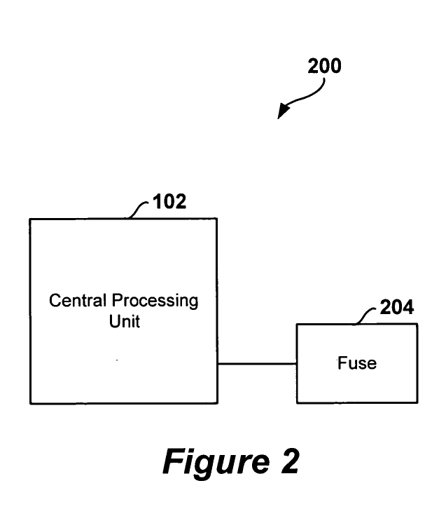

FIG. 2 illustrates another embodiment, wherein the instruction set selector is a fuse 204 that is external to the central processing unit 102. The fuse 204, similar to the embodiment of FIG. 1b, may be embedded within the central processing unit 102. Although a fuse 204 is contemplated, other embodiments of the present invention are possible so long as the instruction set selector 104 is capable of changing the mode within the central processing unit.

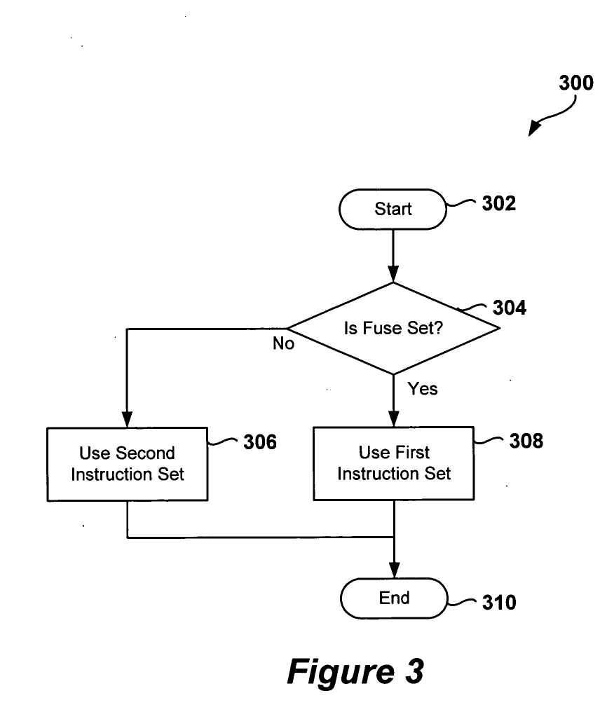

FIG. 3 illustrates a method of selecting an instruction set. The method begins generally at step 302. The central processing unit 102 is given a set of one or more instructions. The question is, under which instruction set are those instructions to be interpreted and executed? To answer that question, a check is made in step 304 to determine of the fuse 204 is set. If the fuse 204 is set, then the central processing unit 102 uses the first instruction set in step 308. Otherwise, the central processing unit 102 uses the second instruction set in step 306. In either case, the instructions are executed and the method ends generally at step 310.

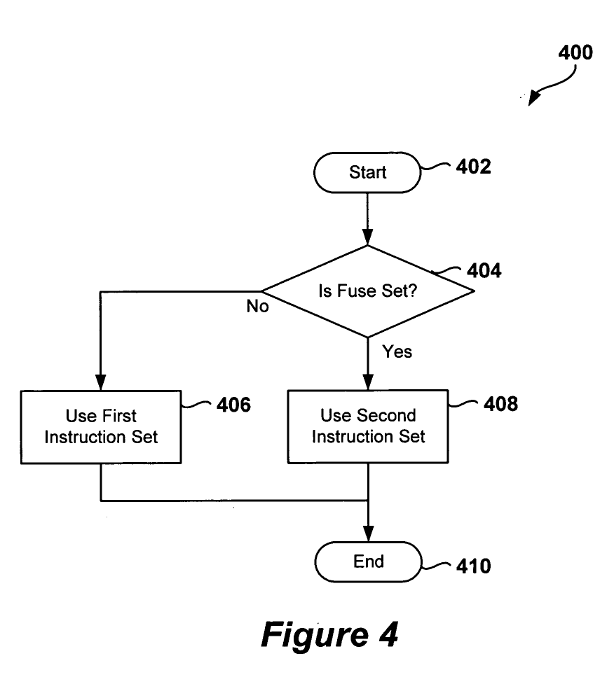

FIG. 4 illustrates another embodiment of the method of selecting an instruction set. In this case, the result of the fuse 204 being set is opposite from the method illustrated in FIG. 3. Referring to FIG. 4, the method begins generally at step 402. The central processing unit 102 is given a set of one or more instructions. A check is made in step 404 to determine of the fuse 204 is set. If the fuse 204 is set, then the central processing unit 102 uses the second instruction set in step 408. Otherwise, the central processing unit 102 uses the first instruction set in step 406. In either case, the instructions are executed and the method ends generally at step 410.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

1. A system for selecting between a first instruction set and a second instruction set for a central processing unit comprising:
a fuse, said fuse operative with said central processing unit;
wherein when said fuse is set to a first value, said central processing unit implements said first instruction set, and when said fuse is set to a second value, said central processing unit implements said second instruction set.

2. The system of claim 1, wherein the first value is ‘1’.

3. The system of claim 1, wherein the second value is ‘1’.

4. The system of claim 1, wherein the first value is ‘0’.

5. The system of claim 1, wherein the second value is ‘0’.

6. A method comprising:
determining if a fuse is set; and
if the fuse is set, then interpreting an instruction according to a first instruction set, otherwise, interpreting the instruction according to a second instruction set.

7. The method of claim 6, wherein the fuse is set with a value of ‘1’.

8. The method of claim 6, wherein the fuse is set with a value of ‘0’.

9. A system for selecting between a instruction set having two or more subsets for a central processing unit comprising:
a fuse, said fuse operative with said central processing unit;
wherein when said fuse is set to a first value, said central processing unit implements a first set of the two or more subsets of the instruction set, and when the fuse is set to a second value, the central processing unit implements a second set of the two or more subsets of the instruction set.

10. The system of claim 9, wherein the first value is ‘1’.

11. The system of claim 9, wherein the second value is ‘1’.

12. The system of claim 9, wherein the first value is ‘0’.

13. The system of claim 9, wherein the second value is ‘0’.
